(19) United States
(12) Patent Application Publication
(10) Pub. No.: US 2026/0316718 A1
(43) Pub. Date: Oct. 15, 2026

(54) CONTROL SYSTEM, VEHICLE ENTRY SYSTEM AND METHOD

(71) Applicant: Nissan Motor Co., Ltd., Kanagawa (JP)

(72) Inventor: Dale Cartledge, Cranfield, Bedfordshire (GB)

(73) Assignee: Nissan Motor Co., Ltd., Kanagawa (JP)

(21) Appl. No.: 19/483,177

(22) PCT Filed: Mar. 26, 2024
(86) PCT No.: PCT/JP2024/011964

§ 371 Date: Nov. 10, 2025

(30) Foreign Application Priority Data
May 16, 2023 (GB) 2307250.7

(51) Int. Cl. B60R 25/24; G07C 9/00

(52) U.S. Cl. CPC B60R 25/24; G07C 9/00309; G07C 2009/00396; G07C 2009/00555

(57) ABSTRACT

An on-board control system for a vehicle has a passive entry function for controlling access to an interior of the vehicle by exchanging wireless communication signals with one or more portable vehicle entry devices. The one or more vehicle entry devices are operable by a user to generate a remote keyless entry command signal for transmission to the on-board control system. The control system is configured to: receive a control signal comprising one or more passive entry function settings from a remote user interface device, the control signal being received over a wireless communication channel; control vehicle accessibility via the passive entry function based on the one or more passive entry function settings of the received control signal; and even when the passive entry function is disabled, grant access to the vehicle in response to receiving the remote keyless entry command signal from the one or more vehicle entry devices.

### TECHNICAL FIELD

The present disclosure relates to a vehicle entry control system. Aspects of the invention relate to a control system, to a vehicle entry system, and to a method of controlling a vehicle. The present application claims priority based on British Patent Application No. 2307250.7 filed on May 16, 2023. For those designated countries which permit the incorporation by reference, the content described and/or illustrated in the above application is incorporated by reference in the present application as part of the description and/or drawings of the present application.

### BACKGROUND ART

Vehicle entry systems are known that include passive entry functions for controlling access to a vehicle without physical interaction with a key fob. The passive entry function typically involves a user actuating an access request switch on a door of the vehicle to trigger a challenge signal, which is sent over a wireless communication channel to a nearby key fob within range of the vehicle, for example as a radio signal. The key fob processes the challenge signal and, in exchange, provides a response signal with an identifier to authorise access to the vehicle. If the response signal is accepted, access to the vehicle may be granted, for example by unlocking a vehicle door.

### PRIOR ART DOCUMENT

### Patent Document

However, vehicles having passive entry functions can be vulnerable to theft by way of a relay attack. During a relay attack, a thief may trigger an access request and use a signal booster to relay the challenge signal from the vehicle, and/or the response signal from the key fob, over larger distances. In this manner, the thief can gain access to the vehicle without the owner's knowledge or permission.

Relay attacks typically happen at night, and it is therefore known to mitigate the risk of a relay attack using a so-called ‘sleeping key’ that further includes an integrated accelerometer for detecting movement of the key fob. Accordingly, if the key fob is left at rest on a surface, and no movement is detected, a controller of the key fob deactivates the communication system after a threshold period has elapsed, thereby preventing the possibility of a relay attack whilst the key fob remains at rest. Upon detecting movement, the key fob is subsequently reactivated and the passive entry capabilities are restored.

However, the ‘sleeping key’ requires additional hardware in the key fob that increases its cost and complexity, whilst offering limited protection against relay attacks. For example, users typically carry key fobs in pockets while indoors and moving around a household, such that the ‘sleeping key’ remains unintentionally active, leaving the system vulnerable to relay attacks.

It is an aim of the present invention to address one or more of the disadvantages associated with the prior art.

### Means for Solving Problems

According to an aspect of the invention there is provided an on-board control system for a vehicle, i.e. a control system for incorporation on-board the vehicle. The control system has a passive entry function for controlling access to an interior of the vehicle by exchanging wireless communication signals with one or more portable vehicle entry devices. The control system is configured to: receive a control signal comprising one or more passive entry function settings from a remote user interface device, the control signal being received over a wireless communication channel; and control vehicle accessibility via the passive entry function based on the one or more passive entry function settings of the received control signal.

In this manner, a user can operate the remote user interface device, which might be a smartphone for example, and send a control signal to the control system with passive entry function settings for controlling an individual's ability to access the vehicle passively, i.e. without the user interacting with the portable vehicle entry device to command vehicle entry. The user can therefore remotely control the passive entry function over the wireless communication channel and conveniently deactivate the passive entry function overnight, for example, to eliminate the risk of an overnight relay attack. Consequently, a conventional portable vehicle entry device, or key fob, can be used to minimise costs, whilst the control system provides for enhanced security and flexibility regarding vehicle access.

It shall be appreciated that the remote user interface device is distinct from a key fob or portable vehicle entry device and provides an interface with one or more control elements for adjusting the passive entry function settings, for example on a downloadable client application, or a web browser application. The remote user interface device is associated with the on-board control system and may, for example, be connected to the control system or otherwise authenticated with reference to a stored register of associated user interface devices or identifiers.

In an example, the passive entry function may comprise: outputting a challenge signal to the one or more vehicle entry devices; receiving a response signal from one of the one or more vehicle entry devices to authorise vehicle access; and determining a command signal to control access to the vehicle in dependence on the received response signal.

Optionally, the one or more passive entry function settings include a respective approval state setting for each of the one or more vehicle entry devices. The passive entry function of the control system may be configured to control access to the vehicle in dependence on the approval state setting of the respective vehicle entry device with which the wireless communication signals are exchanged. In this manner, a user is advantageously able to control vehicle accessibility via respective vehicle entry devices, providing for improved security, for example if one of the vehicle entry devices is missing or lost.

In an example, the control system may be configured to determine the command signal in dependence on the received response signal by checking an approval state setting of the vehicle entry device from which the response signal is received. In this manner, the control system may control vehicle access differently for respective portable vehicle entry devices, for example ignoring access requests from a first vehicle entry device whilst listening for responses from a second vehicle entry device.

Optionally, the one or more passive entry function settings may include a setting for enabling or disabling the passive entry function. The control system may be configured to enable or disable the passive entry function based on the control signal. In this manner, the passive entry function can be entirely enabled/disabled by a user control, e.g. to completely stop the passive entry function.

In an example, the control system may be configured not to output the challenge signal, and/or not to scan for the response signal, when the passive entry function is disabled.

Optionally, the control signal includes a schedule for implementing the one or more passive entry function settings. The control system may be configured to implement the passive entry function settings according to the schedule. In this manner, a user can operate the user interface device to schedule respective passive entry function settings, e.g. to suit a daily/weekly pattern with an optimal balance between security and convenience. This may include a schedule of respective passive entry function settings for respective vehicle entry devices.

In an example, the one or more vehicle entry devices may include a plurality of vehicle entry devices for authorising user access to the vehicle via the passive entry function of the control system. The control system may, for example, be configured to control access to the vehicle by exchanging wireless communication signals with one of the plurality of portable vehicle entry devices.

Optionally, the control system comprises: a first wireless communication module for exchanging the wireless communication signals with the one or more portable vehicle entry devices; and a second wireless communication module for receiving the control signal from the user interface device.

The second wireless communication module may be configured to receive the control signal over a cellular network, for example. For example, the user interface device may send the control signal to a conventional wireless communication module onboard the vehicle that may provide emergency calling services, for example.

Optionally, the control system controls access to the vehicle by generating control signals to a body control module of the vehicle.

According to another aspect of the invention, there is provided a vehicle entry system comprising: the on-board control system as described in a previous aspect of the invention; one or more portable vehicle entry devices; and a user interface device, wherein the user interface device is operably connected to the on-board control system.

The user interface device may, for example, take the form of: a mobile phone device; a smart watch; or a computer.

In an example, the user interface device may be operable to access a downloadable client application, or a web browser application, upon which a control panel is hosted for adjusting the passive entry function settings and generating corresponding control signals for transmission to the on-board control system.

The one or more portable vehicle entry devices may, for example, include a key fob.

The key fob may, for example, be operable by a user to generate a remote keyless entry command signal for transmission to the on-board control system. Optionally, the on-board control system may further include a remote keyless entry function configured to grant access to the vehicle in response to receiving the remote keyless entry command signal from the key fob. In this manner, even when the passive entry function is disabled, vehicle access may still be achieved by operating the key fob to generate a remote keyless entry command signal.

According to another aspect of the invention there is provided a method of controlling access to a vehicle using an on-board control system. The control system has a passive entry function for controlling access to an interior of the vehicle by exchanging wireless communication signals with one or more portable vehicle entry devices. The method comprises: receiving a control signal comprising one or more passive entry function settings, the control signal being received at the control system over a wireless communication channel from a remote user interface device; and controlling vehicle accessibility via the passive entry function based on the one or more passive entry function settings of the received control signal.

The passive entry function may, for example, comprise: outputting a challenge signal from the control system to the one or more vehicle entry devices; receiving a response signal at the control system from one of the one or more vehicle entry devices to authorise vehicle access; and determining a command signal at the control system to control access to the vehicle in dependence on the received response signal.

Optionally, the one or more passive entry function settings include a respective approval state setting for each of the one or more vehicle entry devices. The step of controlling vehicle accessibility based on the one or more passive entry function settings may, for example, comprise controlling vehicle accessibility via the passive entry function independence on the approval state setting of the respective vehicle entry device with which the wireless communication signals are exchanged.

In an example, the step of controlling vehicle accessibility based on the one or more passive entry function settings may comprise determining the command signal in dependence on the approval state setting of the vehicle entry device from which the response signal is received.

Optionally, the one or more passive entry function settings include a setting for enabling or disabling the passive entry function. The step of the controlling vehicle accessibility based on the one or more passive entry function settings may, for example, comprise enabling or disabling the passive entry function based on the control signal.

Optionally, the control system is configured not to output the challenge signal, and/or not to scan for the response signal, when the passive entry function is disabled.

The control signal may, for example, include a schedule for implementing the one or more passive entry function settings. The control system may implement the one or more passive entry function settings according to the schedule to control vehicle accessibility via the passive entry function.

Optionally, the method further comprises: transmitting the control signal from the user interface device in dependence on one or more user operable switches of a control panel being operated on the user interface device to adjust the one or more passive entry function settings.

Optionally, the user interface device is operable to access a downloadable client application, or a web browser application, upon which the control panel is hosted. It will be appreciated that preferred and/or optional features of each aspect of the invention may be incorporated alone or in appropriate combination in the other aspects of the invention also.

### Effects of Invention

According to the present invention, a conventional portable vehicle entry device, or key fob, can be used to minimise costs, whilst the control system provides for enhanced security and flexibility regarding vehicle access.

One or more embodiments of the invention will now be described below, by way of example only, with reference to the accompanying drawings

### BRIEF DESCRIPTION OF DRAWINGS

FIG. 1 shows an illustration of an example vehicle in accordance with an embodiment of the invention;

FIG. 2 shows a schematic illustration of an example vehicle entry control system wirelessly connected to a user interface device, in accordance with an embodiment of the invention;

FIG. 3 schematically illustrates a first example control panel of the user interface device for controlling vehicle accessibility via a passive entry function;

FIG. 4 schematically illustrates a second example control panel of the user interface device for controlling vehicle accessibility via the passive entry function;

FIG. 5 schematically illustrates a third example control panel of the user interface device for controlling vehicle accessibility via the passive entry function; and

FIG. 6 illustrates an example method in accordance with an embodiment of the invention of operating the vehicle entry control system, shown in FIG. 2, to control access to the vehicle shown in FIG. 1.

### MODE FOR CARRYING OUT THE INVENTION

Embodiments of the invention relate to a vehicle entry system, and to a method, for controlling access to a vehicle.

The vehicle entry system includes a control system on-board the vehicle having a passive entry function for controlling access to the vehicle via one or more portable vehicle entry devices, or key fobs. Such passive entry key fobs are provided with wireless communication systems such that they can communicate with the on-board control system and authorise one or more vehicle actions, such as unlocking/locking the vehicle doors.

As part of the passive entry function, the on-board control system is therefore configured to exchange signals with one or more nearby portable vehicle entry devices to authorise access to the vehicle. The passive entry function may be triggered in this manner, for example, by a user operating an access request switch on a door handle of the vehicle.

Advantageously though, in order to mitigate the risk of relay-attacks, the on-board control system of the invention is further configured to exchange signal(s) with an associated remote user interface device, such as a smart phone or tablet computing device, and to control vehicle accessibility via the passive entry function based on a control signal comprising one or more passive entry function settings received from the user interface device.

In particular, the user interface device is operable to control whether or not it is possible for a user to passively access the vehicle via the passive entry function, i.e. using the portable vehicle entry device. In examples, the on-board control system may be configured to selectively enable or disable the passive entry function, in its entirety, based on the settings/control signal(s) received from the user interface device, or the on-board control system may be configured to adjust individual approval state settings associated with respective vehicle entry devices based on such control signal(s).

In this manner, a user can remotely control the ability to access the vehicle via the passive signal exchanges between the control system and the portable vehicle entry device based on the passive entry function settings provided by a connected user interface device, such as a mobile phone. This provides a convenient remote interface to the on-board vehicle control system. A user is therefore able to operate the user interface device from inside a household to disable the passive entry function at night, such that vehicle access via the passive entry function is denied, eliminating the risk of overnight relay attacks, and the passive entry function can be reenabled via the user interface device in the morning to resume normal operation.

It is envisaged that the vehicle entry system will therefore provide for enhanced vehicle security and mitigate acts of theft, whilst also providing for increased vehicle access flexibility, as shall be discussed in further detail in the description that follows.

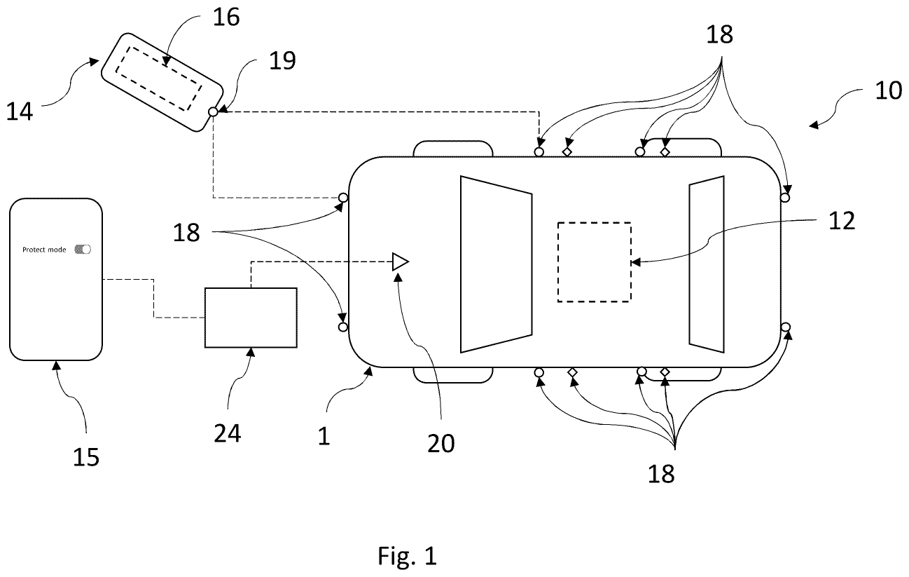

Embodiments of the vehicle entry system shall now be considered in more detail with reference to FIGS. 1 to 6.

FIG. 1 shows an exemplary vehicle 1 featuring a vehicle entry system 10 in accordance with an embodiment of the invention.

As shown in FIG. 1, the vehicle entry system 10 includes an on-board vehicle control system 12, one or more associated portable vehicle entry devices 14 and a user interface device 15 operably connected to the on-board control system 12.

The on-board control system 12 is configured to control user access to the vehicle 1, for example through one or more vehicle doors (not shown). For this purpose, the control system 12 includes a passive entry function, according to which the control system 12 exchanges signals with any nearby vehicle entry device(s) 14 to: (i) challenge the identity of the vehicle entry device 14, and (ii) authorise access to the vehicle 1 if a suitable response signal is provided.

The control system 12 therefore includes a first set of antennas 18 for communicating with the vehicle entry device(s) 14 over one or more wireless communication channels. For example, the first set of antennas 18 may be configured to communicate with the vehicle entry device(s) 14 using short range signals, including Bluetooth® Low Energy (Bluetooth® LE) signals or low frequency (LF) radio signals, and/or via longer range signals, where different signal frequencies may be preferable between longer range and shorter-range transmissions.

The first set of antennas 18 may therefore include one or more transmitters, one or more receivers and/or one or more transceivers for this purpose. To give an example, the first set of antennas 18 may include a set of Bluetooth® LE or LF radio antennas arranged around the vehicle 1, as shown in FIG. 1, configured to exchange signals with one or more portable vehicle entry devices 14, as they move into the proximity of the vehicle 1. For context, the range of such signal exchanges may correspond to a threshold distance for physical interaction with the vehicle, for example being limited to a range of approximately two metres. This may ensure that the passive entry function is carried out when the user is present at the vehicle. However, this example is not intended to be limiting on the scope of the invention and, in other examples, the operational range may be considerably larger, for example up to ten metres to allow signal exchanges as a user approaches the vehicle 1, for example.

The vehicle entry device(s) 14 may take the form of key fob(s), for example, equipped with wireless communication means to exchange signals with the on-board control system 12 and thereby passively authorise entry to the vehicle, i.e. without user interaction with the vehicle entry device 14.

For this purpose, each vehicle entry device 14 may include, amongst other components, a controller 16, and one or more corresponding antennas 19 (i.e. one or more corresponding transmitters, receivers, and/or transceivers) for exchanging signals with the first set of antennas 18 mounted on-board the vehicle 1.

The controller 16 is configured to process signals received from the on-board control system 12 and to generate corresponding response signals for transmission to the vehicle 1. In particular, the controller 16 may be configured to receive an authentication challenge signal from the on-board control system 12, as part of a passive entry function, and to generate a corresponding authorisation signal in response. For example, the response signal may include a key code, or any other suitable identifier of the vehicle entry device 14, that can be checked by the on-board control system 12 to verify the authorisation of that vehicle entry device 14. Once verified, the on-board control system 12 can execute one or more control actions, such as granting access to the vehicle 1.

Advantageously, in order to mitigate the risk of relay attacks, the on-board control system 12 is further configured to exchange signals with a remote user interface device 15, such as a smart phone or personal computing device, and to control vehicle accessibility via the passive entry function of the control system 12 based on one or more settings/control signals received from the remote user interface device 15.

In this manner, a user can remotely control the ability to access the vehicle 1 via the passive signal exchanges between the control system 12 and the portable entry device(s) 14 using the settings received from a separate user interface device 15, such as a mobile phone.

The user interface device 15 therefore provides a convenient control panel for remotely adjusting settings of the on-board vehicle control system 12, such as the passive entry function settings. For example, the user interface device 15 may be operated by a user to selectively enable or disable the passive entry function of the control system 12, or the user interface device 15 may be operated to adjust individual approval state settings associated with respective vehicle entry devices 14 in the passive entry function.

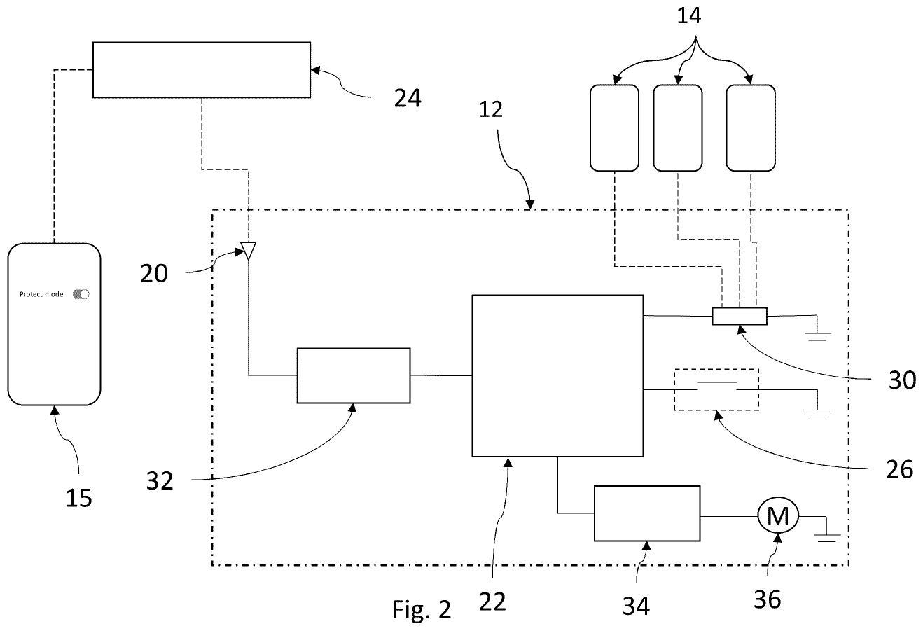

For this purpose, the control system 12 may include a second set of one or more antennas 20 for wirelessly communicating with the associated user interface device 15. In examples, the second set of antennas 20 may be the same as the first set of antennas 18, or form a further set of antennas, and may therefore include one or more transmitters, receivers and/or transceivers configured to exchange signals with the user interface device 15 over one or more wireless communication channels. In examples, the communication channels may include channels using a telematic communication protocol that is typically used to connect the vehicle 1 to cloud services over a cellular network. Such signals may therefore be exchanged via an intermediate server 24, as shall be described in more detail with reference to FIG. 2.

The user interface device 15 may take various suitable forms for controlling the passive entry function settings, and may therefore include any suitable computer hardware or processing device, such as a mobile phone, computer, or media player, configured to exchange communication signals over one or more wireless communication channels with the on-board vehicle control system 12.

In each case, the user interface device 15 may provide means, such as a graphical user interface, for accessing an application or platform upon which a control panel is hosted for adjusting the passive entry function settings and generating corresponding command signals. To give an example, the graphical user interface may be comprised in a downloadable client application or a web browser application, providing the application data and instructions required to access the control panel and to control the vehicle accessibility by the passive entry function via one or more interactions therewith, as shall be described in more detail. In this manner, the client application may be downloaded to any suitable user interface device 15 and used to associate the user interface device 15 with the vehicle 1 and control the passive entry function settings, for example over a cellular network

The vehicle entry system 10 shall now be considered in more detail with additional reference to FIG. 2.

FIG. 2 schematically illustrates an exemplary vehicle entry system 10 in accordance with an embodiment of the invention.

As shown in FIG. 2, the on-board control system 12 includes one or more controllers or in-vehicle modules for performing respective functions relating to the vehicle entry control.

In this example, the control system 12 is shown to include a vehicle entry control module 22, an access request switch 26, a first wireless communication module 30, a second wireless communication module 32, and a body control module 34 for controlling one or more vehicle functions in a body of the vehicle 1

That is, in the described example five functional elements, units or modules are shown. Each of these units or modules may be provided, at least in part, by suitable software running on any suitable computing substrate using conventional or customer processors and memory. Some or all of the units or modules may use a common computing substrate (for example, they may run on the same server) or separate substrates, or different combinations of the modules may be distributed between multiple computing devices. The example architecture of the control system 12 is not intended to be limiting on the scope of the invention though and, in other examples, it shall be appreciated that the architecture may take other suitable forms.

The vehicle entry control module 22 and the associated in-vehicle modules are operatively connected to different systems within the vehicle 1. For example, the first set of antennas 18 are incorporated into, or otherwise operably connected to, the first wireless communication module 30 and the second set of antennas 20 are incorporated into, or otherwise operably connected to, the second wireless communication module 32 to allow for transmission and receipt of respective signals between the on-board control system 12, the portable vehicle entry device(s) 14, and the user interface device 15.

The access request switch 26 is operable by a user to trigger an access request to the vehicle 1, and thereby to initiate the passive entry function. In particular, the access request switch 26 is connected to the vehicle entry control module 22 and configured to output an access request signal to the vehicle entry control module 22, once operated. For this purpose, the access request switch may take one or more forms that are known in the art, including that of a door-mounted access request switch that provides a user operable switch or button on a door handle, for example, or another form of switch, such as a capacitance switch. Such access request switches are well known in the art and are not described in detail here to avoid obscuring the invention.

The vehicle entry control module 22 acts as a central controller of the system 12 and executes the passive entry function by interacting with the further modules of the control system 12. In particular, in response to receiving the access request signal from the access request switch 26, the vehicle entry control module 22 is configured to operate the first wireless communication module 30 to transmit the challenge signal to any nearby vehicle entry devices 14 and to listen or scan for respective response signals. Any response signals received by the first set of antennas 18 are subsequently relayed to the vehicle entry control module 22 and processed by the vehicle entry control module 22 to determine whether to grant access to the vehicle 1. For example, the vehicle entry control module 22 may be configured to process the response signal and perform one or more checks for granting access to the vehicle. Such checks may, for example, include checking a received signal strength indication (RSSI) of the response signal, checking an identifier of the response signal (e.g. against a list of authorised vehicle entry devices 14), and/or checking an approval state setting of the identified vehicle entry device 14. If a suitable response signal is received, the vehicle entry control module 22 may therefore generate a command signal to the body control module 34 to grant the user access to the vehicle 1.

The body control module 34 is configured to control access to the vehicle 1 and may be operatively connected to one or more further systems within the vehicle 1, including a door control system 36 for example, as shown in FIG. 2. The door control system 36 may further include one or more sub-systems (not shown), such as a door lock motor system, for controlling access to the vehicle 1 via the vehicle doors. Accordingly, the body control module 34 may be configured to execute one or more control actions to lock or unlock the vehicle doors in response to a command signal from the vehicle entry control module.

According to embodiments of the invention, the vehicle entry control module 22 is advantageously further operably connected to the remote user interface device 15, and configured to exchange signals therewith, via the second wireless communication module 32, to control vehicle accessibility via the passive entry function.

The signal exchanges may take place via one or more centralised servers 24 to facilitate connection to, and/or authentication of, the user interface device 15 (e.g. in addition to its association with the vehicle 1). The centralised server 24 may be operated by the vehicle manufacturer, for example, or another party, such as a licensed third party. For this purpose, the centralised server(s) 24 may store a register of associated user interface device identifiers and respective vehicle identifiers, for example.

In examples, the centralised server(s) 24 may alternatively or additionally be implemented as a cloud-based computing environment, where the functionalities of the server(s), are executed in a distributed fashion. Such systems that provide cloud-based resources may be utilized exclusively by their owners or such systems may be accessible to outside users who deploy applications within the computing infrastructure to obtain the benefit of large computational or storage resources.

The second wireless communication module 32 is therefore configured to operate the second set of antennas 20 to exchange signals with the user interface device 15, for example via the intermediate cloud-based or centralised server 24.

In examples, the second wireless communication module 32 may be configured to exchange signals with the user interface device 15 over a Cellular network (e.g. GSM®, General Packet Radio Service (GPRS), Wi-Fi®, WiMax®, LTE & or 5G). For example, the second wireless communication module 32 may take the form of a telematic control unit or hands-free module of the vehicle 1. Telematics control units typically include a mobile communication unit and an external interface for mobile communication in order to facilitate emergency telephone services, and the invention may therefore take advantage of the same telematic communication channel to provide control of the passive entry function via the user interface device 15. Such on-board emergency call facilities are mandatory for new vehicles in certain territories/regions, such as in the European region, and such telematics control units are therefore provided as standard on many modern vehicles.

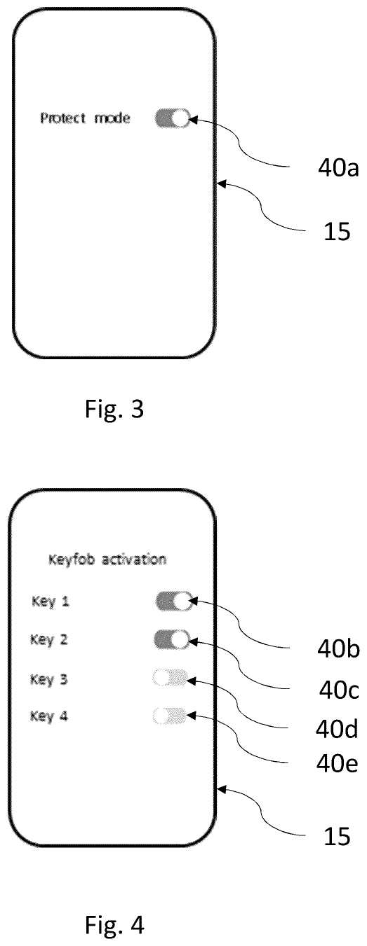

The user interface device 15 is therefore operable to control vehicle accessibility via the passive entry function. For this purpose, the user interface device 15 may access one or more downloadable client applications, web browser applications or platforms upon which one or more control panels are provided for controlling settings of the passive entry function. The applications or platforms provide application data and instructions required to access the control panel and to control the vehicle accessibility via one or more interactions therewith, as shall be described in more detail with reference to the following examples shown in FIGS. 3 to 5.

According to a first client application or platform, the user interface device is operable to enable or disable the passive entry function of the vehicle entry control module 22 in its entirety.

For this purpose, the first client application/platform may provide the user interface with a simple control panel including a first user operable switch 40a for enabling or disabling the passive entry function, illustrated by way of a non-limiting example in FIG. 3.

Upon operating the first switch 40a to disable the passive entry function, the user interface device 15 may generate a corresponding control signal for transmission to the vehicle 1, for example via the centralised server 24.

The control signal may be received by the second wireless control module 32 and passed to the vehicle entry control module 22. In response, the vehicle entry control module 22 may process the control signal and disable the passive entry function to prevent access to the vehicle 1 via the passive entry function. For example, in response to the control signal, the vehicle entry control module 22 may be configured to ignore access request signals from the access request switch 26 while the passive entry function is disabled.

For example, while the passive entry function is disabled, the vehicle entry control module 22 may be configured not to generate or transmit challenge signals via the first wireless communication module 30. Alternatively or additionally, the vehicle entry control module 22 may be configured to operate the first wireless communication module 30 so as not to listen or scan for response signals. In other examples, the vehicle entry control module 22 may be configured to continue to transmit challenge signals and to listen/scan for response signals while the passive entry function is disabled, but simply reject all response signals received from the vehicle entry devices 14.

Accordingly, in response to the control signal(s) received from the user interface device 15, the vehicle entry control module 22 may be configured to selectively enable or disable the passive entry function, in its entirety.

In this manner, a user may operate the user interface device 15 to disable the passive entry function upon entering the household, and thereby eliminate the risk of relay attacks, even whilst carrying the vehicle entry device 14 on their person. The user may subsequently operate the user interface device 15, for example in the morning, to reenable the passive entry function for convenient access to the vehicle 1 during the day.

In another example, a user may leave the vehicle entry device 14 inside the vehicle 1, within a suitable range for the passive signal exchanges, but disable the passive entry function via the user interface device 15 in order to lock the vehicle 1 and prevent access thereto until the passive entry function is reenabled. In this manner, the vehicle entry device 14 can be safely stored inside the vehicle 1, for example while the user is away from the vehicle 1 (e.g. with limited pocket space), and the passive entry function may subsequently be reenabled to unlock the vehicle 1 via the passive entry function.

According to a second client application or platform, the user interface device 15 is operable to control respective approval state settings associated with each vehicle entry device 14 in the passive entry function.

For this purpose, the second client application/platform may provide the user interface with a second control panel including a plurality of user operable switches 40b-e for selecting an approval state setting of respective vehicle entry devices 14, as illustrated by way of a non-limiting example in FIG. 4.

Accordingly, upon operating ones of the switches 40b-e to change the approval state setting of a respective vehicle entry device 14, the user interface device 15 may generate a corresponding control signal for transmission to the vehicle 1, for example via the centralised server 24.

The vehicle entry control module 22 may therefore receive a corresponding control signal to change an approval state setting of the respective vehicle entry device 14 to approve or deny response signals from that vehicle entry device 14. In response to receiving the control signal, the vehicle entry control module 22 may therefore change an approval state setting associated with the identifier of that vehicle entry device 14 in the passive entry function.

Accordingly, the passive entry function remains enabled and, in response to an access request signal from the access request switch 26, the vehicle entry control module 22 is configured to operate the first wireless communication module 30 to transmit a challenge signal and listen/scan for response signals. However, upon receiving a response signal, the vehicle entry control module 22 processes the response signal to determine an identity of the vehicle entry device 14 and reviews the approval state setting of the identified vehicle entry device 14 to determine whether or not to generate a command signal to grant access to the vehicle 1.

It shall be appreciated that, in this scenario, the approval state settings may be applicable to individual vehicle entry devices 14 or groups of vehicle entry devices 14 and therefore the vehicle entry control module 22 continues to operate the passive entry function and grants passive access to the vehicle 1 to approved vehicle entry devices 14, whilst denying vehicle access to those vehicle entry devices 14 that are not approved.

According to a third client application or platform, the user interface device 15 is operable to schedule respective periods during which the vehicle 1 is accessible via the passive entry function. In particular, the user interface device 15 is operable to schedule respective periods for implementing the passive entry function settings. For example, the user interface device 15 is operable to schedule respective periods during which the passive entry function is either enabled or disabled (in its entirety), or to schedule the approval state settings of each vehicle entry device 14 for respective periods, substantially as described above.

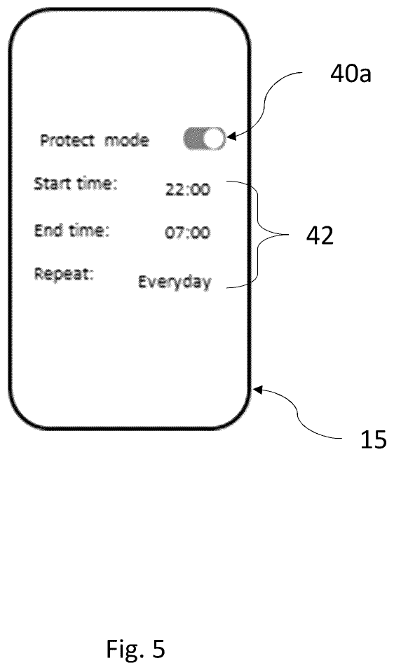

For this purpose, the third client application/platform may provide the user interface device 15 with a control panel including any one or more of the user operable switches 40a-e described above, in addition to one or more control options 42 for scheduling such settings, as illustrated in the non-limiting example of FIG. 5. For example, the control panel may include one or more options 42 for setting a duration of the respective setting, such as a start time, an end time, a frequency, and/or a date or range of dates, as shown. It shall be appreciated that the scheduling options 42 are not limited to those options shown in FIG. 5 and may include any time, date, frequency or condition based requirements for implementing the respective passive entry function settings.

The details of the settings are therefore communicated in one or more control signals transmitted from the user interface device 15 to the vehicle entry control module 22. The vehicle entry control module 22 may be configured to receive the control signal(s) and to schedule the implementation of such passive entry function settings, substantially as described previously.

For example, during a scheduled period for disabling the passive entry function, the vehicle entry control module 22 may be configured not to generate or transmit challenge signals via the first wireless communication module 30 or to operate the first wireless communication module 30 so as not to listen/scan for response signals. Alternatively or additionally, where the approval state setting of a first vehicle entry device 14 is changed to deny access for a scheduled period, the vehicle entry control module 22 may be configured to continue transmitting challenge signals and listening/scanning for response signals following an access request, but upon receiving a response signal from that vehicle entry device 14, the vehicle entry control module 22 will not generate a command signal to grant access to the vehicle 1.

In this manner, a user may operate the user interface device 15 to schedule periods during which the passive entry function is disabled, and thereby eliminate the risk of overnight relay attacks, whilst the passive entry function may be reenabled during the daytime for convenient operation without further control inputs.

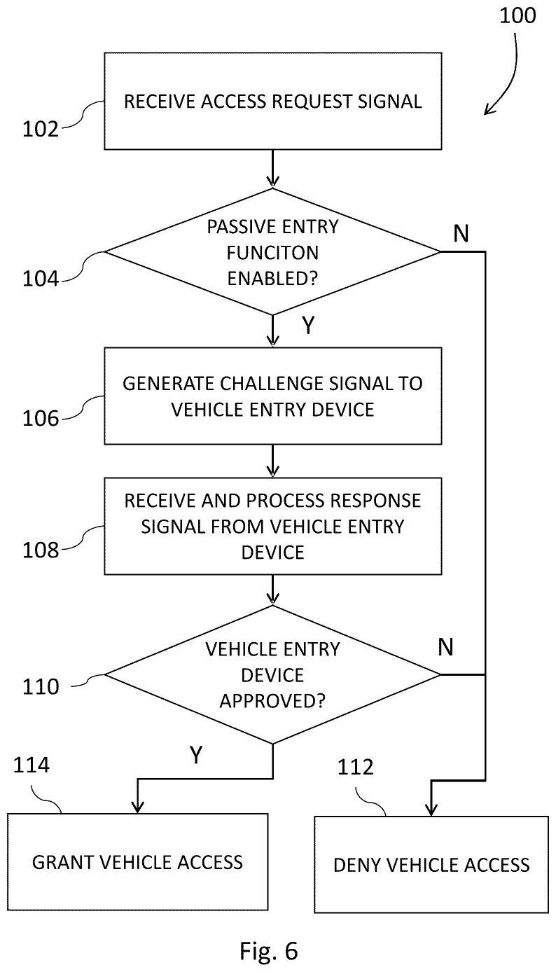

FIG. 6 shows an example method 100 of operating the vehicle entry system 10, in accordance with an embodiment of the disclosure.

In an example scenario, a user may be carrying a vehicle entry device 14, for example in a pocket, and approach the vehicle 1. The user may then operate the access request switch 26 on the vehicle door to request access to the vehicle 1 via the passive entry function.

In step 102, the vehicle entry control module 22 therefore receives an access request signal from the access request switch 26.

Upon receiving the access request signal, the vehicle entry control module 22 may be configured to check whether the passive entry function is enabled, in step 104.

As discussed previously, the passive entry function may have been disabled following a control signal received from the user interface device 15. For example, a user may have interacted with a client application of the user interface device 15 to selectively enable or disable the passive entry function or to schedule respective periods during which the passive entry function is enabled or disabled. To give an example, a user may have operated the first switch 40a of the control panel shown in FIG. 3 to disable or enable the passive entry function.

Accordingly, if the passive entry function is disabled when the access request signal is received, the vehicle entry control module 22 is configured to deny vehicle access in step 112. For example, the vehicle entry control module 22 may refuse to perform one or more of the subsequent steps of the method 100, as shall be discussed in more detail, such that access to the vehicle is denied, for example with the door control system 36 maintaining the vehicle door in a locked or otherwise closed state.

Alternatively, if the passive entry function is enabled when the access request signal is received, the vehicle entry control module 22 may be configured to generate a challenge signal for transmission to nearby vehicle entry devices 14, in step 106. For example, the first wireless communication module 30 may be controlled to transmit a challenge signal to any nearby vehicle entry devices 14 within communication range of the first set of antennas 18.

The vehicle entry device 14 carried by the user therefore receives the challenge signal and generates a response signal to identify the vehicle entry device 14, which is transmitted back to the first wireless communication module 30.

In step 108, the vehicle entry control module 22 is therefore configured to receive and to process the response signal from the vehicle entry device 14. As described previously, the vehicle entry control module 22 may process the response signal to identify the vehicle entry device 14 and to check the approval state setting of that vehicle entry device 14.

Accordingly, in step 110, the vehicle entry control module 22 is configured to check whether the identified vehicle entry device 14 is approved for the passive entry function.

As discussed previously, the approval state setting of the identified vehicle entry device 14 may have been altered following a control signal received from the user interface device 15. For example, a user may have interacted with a client application of the user interface device 15 to selectively switch the approval state setting of a respective vehicle entry device 14 between approved and disapproved states, or to schedule respective periods during which that vehicle entry device 14 is approved or not approved for vehicle access by the passive entry function. To give an example, a user may have operated one of the plurality of switches 40b-e on the downloadable control panel shown in FIG. 4 to adjust the approval state setting of a respective vehicle entry device 14.

Accordingly, if vehicle entry by the passive entry function is not approved for the vehicle entry device 14 when the response signal is received, the vehicle entry control module 22 is configured to deny vehicle access, in step 112. For example, the door control system 36 may be operated to maintain the vehicle door in a locked or otherwise closed state.

Alternatively, if vehicle entry by the passive entry function is approved for the vehicle entry device 14 when the response signal is received, the vehicle entry control module 22 may be configured to generate a command signal to the body control module 34, in step 114, to grant access to the vehicle 1. For example, the vehicle entry control module 22 may command the door control system 36 to execute one or more control actions, such as unlocking the vehicle doors and/or opening the vehicle doors, to grant access to the vehicle 1.

It shall be appreciated that the control system 12 may therefore execute each of the steps 102 to 114 in response to a passive access request and, at any time, a user may operate the user interface device 15 to change the passive entry function settings and thereby control vehicle accessibility via the passive entry function.

In this manner, the invention provides for improved control of the passive entry function of the vehicle 1, providing enhanced security and defence against relay attacks and increased operational flexibility.

It will be appreciated that various changes and modifications can be made to the present invention without departing from the scope of the present application.

In examples, the vehicle entry device(s) 14 may be further configured to act as remote keyless entry devices and be operable to transmit one or more command signals to the vehicle entry control module 22 for controlling access to the vehicle via active commands from a user, for example as an alternative to the passive signal exchanges. In examples, the additional remote keyless entry function allows a user to control access to the vehicle, by operating one or more controls of the vehicle entry device 14, when vehicle access via the passive entry function of the control system 12 is prevented. It shall be appreciated that the remote keyless entry function may be executed by signal transmission over a radio frequency, while the passive entry function may be executed by signal exchanges over a lower frequency communication channel, such as LF radio or Bluetooth® LE. For this purpose, the on-board control system 12 may include one or more further antennas (not shown) connected to the vehicle entry control module 22, i.e. for receiving the remote command signals. The remote keyless entry function is well-known in the art though and shall not be described in detail here to avoid obscuring the invention. It shall be appreciated that the remote keyless entry function may therefore be operated independently of the passive entry function.

In other examples, the on-board control system 12 and the vehicle entry devices 14 may be configured to provide one or more further passive control actions based on the passive signal exchanges. For example, the on-board control system 12 and the vehicle entry devices 14 may be configured to provide a passive entry passive start (PEPS) function, and the on-board control system 12 may therefore be further configured to generate a control signal to one or more further systems, such as an engine control unit (not shown), of the vehicle 1 to perform an engine start operation in addition to granting vehicle access.

1. An on-board control system for a vehicle, the control system having a passive entry function for controlling access to an interior of the vehicle by exchanging wireless communication signals with one or more portable vehicle entry devices, the one or more vehicle entry devices being operable by a user to generate a remote keyless entry command signal for transmission to the on-board control system, wherein the control system is configured to:
receive a control signal comprising one or more passive entry function settings from a remote user interface device, the control signal being received over a wireless communication channel;
control vehicle accessibility via the passive entry function based on the one or more passive entry function settings of the received control signal; and
even when the passive entry function is disabled, grant access to the vehicle in response to receiving the remote keyless entry command signal from the one or more vehicle entry devices.

2. A control system according to claim 1, wherein the passive entry function comprises:
outputting a challenge signal to the one or more vehicle entry devices;
receiving a response signal from one of the one or more vehicle entry devices to authorise vehicle access; and
determining a command signal to control access to the vehicle in dependence on the received response signal.

3. A control system according to claim 1, wherein the one or more passive entry function settings include a respective approval state setting for each of the one or more vehicle entry devices; and
wherein the passive entry function of the control system is configured to control access to the vehicle in dependence on the approval state setting of the respective vehicle entry device with which the wireless communication signals are exchanged.

4. A control system according to claims 2, wherein the control system is configured to determine the command signal in dependence on the received response signal by checking an approval state setting of the vehicle entry device from which the response signal is received.

5. A control system according to claim 1, wherein the one or more passive entry function settings include a setting for enabling or disabling the passive entry function; and the control system is configured to enable or disable the passive entry function based on the control signal.

6. A control system according to claim 5, when dependent on claim 2, wherein the control system is configured not to output the challenge signal, and/or not to scan for the response signal, when the passive entry function is disabled.

7. A control system according to claim 1, wherein the control signal includes a schedule for implementing the one or more passive entry function settings; and wherein the control system is configured to implement the passive entry function settings according to the schedule.

8. A control system according to claim 1, wherein the one or more vehicle entry devices include a plurality of vehicle entry devices for authorising user access to the vehicle via the passive entry function of the control system; and the control system is configured to control access to the vehicle by exchanging wireless communication signals with one of the plurality of portable vehicle entry devices.

9. A control system according to claim 1, comprising: a first wireless communication module for exchanging the wireless communication signals with the one or more portable vehicle entry devices; and a second wireless communication module for receiving the control signal from the user interface device.

10. A control system according to claim 9, wherein the second wireless communication module is configured to receive the control signal over a cellular network.

11. A control system according to claim 1, wherein the control system controls access to the vehicle by generating control signals to a body control module of the vehicle.

12. A vehicle entry system comprising: the on-board control system of claim 1; one or more portable vehicle entry devices; and a user interface device, wherein the user interface device is operably connected to the on-board control system.

13. A vehicle entry system according to claim 12, wherein the user interface device takes the form of:
a mobile phone device;
a smart watch; or
a computer.

14. A vehicle entry system according to claim 13, wherein the user interface device is operable to access a downloadable client application, or a web browser application, upon which a control panel is hosted for adjusting the passive entry function settings and generating corresponding control signals for transmission to the on-board control system.

15. A vehicle entry system according to claim 12, wherein the one or more portable vehicle entry devices includes a key fob.

16. A vehicle entry system according to claim 15, wherein the key fob is operable by a user to generate a remote keyless entry command signal for transmission to the on-board control system; and wherein the on-board control system further includes a remote keyless entry function configured to grant access to the vehicle in response to receiving the remote keyless entry command signal from the key fob.

17. A method of controlling access to a vehicle using an on-board control system, the control system having a passive entry function for controlling access to an interior of the vehicle by exchanging wireless communication signals with one or more portable vehicle entry devices, the one or more vehicle entry devices being operable by a user to generate a remote keyless entry command signal for transmission to the on-board control system, wherein the method comprises;
receiving a control signal comprising one or more passive entry function settings, the control signal being received at the control system over a wireless communication channel from a remote user interface device;
controlling vehicle accessibility via the passive entry function based on the one or more passive entry function settings of the received control signal; and
even when the passive entry function is disabled, granting access to the vehicle in response to receiving the remote keyless entry command signal from the one or more vehicle entry devices.

18. A method according to claim 17, wherein the passive entry function comprises:
outputting a challenge signal from the control system to the one or more vehicle entry devices;
receiving a response signal at the control system from one of the one or more vehicle entry devices to authorise vehicle access; and
determining a command signal at the control system to control access to the vehicle in dependence on the received response signal.

19. A method according to claim 17, wherein the one or more passive entry function settings include a respective approval state setting for each of the one or more vehicle entry devices; and wherein controlling vehicle accessibility based on the one or more passive entry function settings comprises controlling vehicle accessibility via the passive entry function in dependence on the approval state setting of the respective vehicle entry device with which the wireless communication signals are exchanged.

20. A method according to claim 18, wherein controlling vehicle accessibility based on the one or more passive entry function settings comprises determining the command signal in dependence on the approval state setting of the vehicle entry device from which the response signal is received.

21. A method according to claim 17, wherein the one or more passive entry function settings include a setting for enabling or disabling the passive entry function; and
the controlling vehicle accessibility based on the one or more passive entry function settings comprises enabling or disabling the passive entry function based on the control signal.

22. A method according to claim 21, wherein the passive entry function comprises:
outputting a challenge signal from the control system to the one or more vehicle entry devices;
receiving a response signal at the control system from one of the one or more vehicle entry devices to authorise vehicle access; and
determining a command signal at the control system to control access to the vehicle in dependence on the received response signal, and
wherein the control system is configured not to output the challenge signal, and/or not to scan for the response signal, when the passive entry function is disabled.

23. A method according to claim 17, wherein the control signal includes a schedule for implementing the one or more passive entry function settings; and
the one or more passive entry function settings are implemented according to the schedule to control vehicle accessibility via the passive entry function.

24. A method according to claim 17, further comprising:
transmitting the control signal from the user interface device in dependence on one or more user operable switches of a control panel being operated on the user interface device to adjust the one or more passive entry function settings.

25. A method according to claim 24, wherein the user interface device is operable to access a downloadable client application, or a web browser application, upon which the control panel is hosted.
